(19) United States
(12) Patent Application Publication
(10) Pub. No.: US 2025/0264584 A1
(43) Pub. Date: Aug. 21, 2025

(54) CONTROLLER, OPTICAL DETECTION SYSTEM, CONTROL METHOD AND STORAGE MEDIUM STORING CONTROL PROGRAM

(71) Applicant: DENSO CORPORATION, Kariya-city (JP)

(72) Inventor: Tomonari YOSHIDA, Kariya-city (JP)

(21) Appl. No.: 19/202,630

(22) Filed: May 8, 2025

Related U.S. Application Data
(63) Continuation of application No. PCT/JP2023/034453, filed on Sep. 22, 2023.

(30) Foreign Application Priority Data
Nov. 22, 2022 (JP) 2022-186709

(51) Int. Cl. G01S 7/4863; G01S 7/484; G01S 17/10

(52) U.S. Cl. CPC G01S 7/4863; G01S 7/484; G01S 17/10

(57) ABSTRACT

A controller for an optical sensor including a SPAD pixel includes a processor. The processor controls irradiation lights to be emitted respectively in each of detection intervals. The irradiation lights including reference light and multiple types of delayed lights for each detection frame. The reference light is emitted at a start timing of a detection interval, and the multiple types of delayed lights are emitted with delays from start timings of detection intervals and different in delay by a delay interval from each other. Response output of the SPAD pixel is repeatedly sampled at sampling intervals during each detection interval, and accumulated for detection intervals to obtain time distribution of an output accumulated value. The processor outputs data of a distance to a target according to a specific divided period, which is specified based on the time distribution of the output accumulated value.

### CROSS REFERENCE TO RELATED APPLICATIONS

The present application is a continuation application of International Patent Application No. PCT/J P 2023/034453 filed on Sep. 22, 2023, which designated the U.S. and claims the benefit of priority from Japanese Patent Application No. 2022-186709 filed on Nov. 22, 2022. The entire disclosures of all the above applications are incorporated herein by reference.

### TECHNICAL FIELD

The present disclosure relates to a control technique for an optical sensor.

### BACKGROUND

Optical sensors that detect the distance to a target by using Single Photon Avalanche Diode (i.e., SPAD) pixels to receive reflected light that is emitted by illumination and reflected by the target have been attracting attention.

### SUMMARY

According to a first aspect of the present disclosure, a controller configured to control an optical sensor is provided. The optical sensor is configured to detect a distance to a target by receiving reflected lights from the target with a SPAD pixel. The reflected lights are irradiation lights by light emission. The controller includes a processor. The processor is configured to control the irradiation lights to be emitted respectively in each of detection intervals. The irradiation lights include reference light and multiple types of delayed lights for each detection frame. The reference light is emitted at a start timing of a detection interval. The multiple types of delayed lights are emitted with delays from start timings of detection intervals and different in delay by a delay interval from each other. Each of the detection intervals is a duration during which response output of the SPAD pixel is repeatedly sampled at sampling intervals. Each of the sampling intervals is greater than the delay interval. Each detection frame is a duration for obtaining time distribution of an output accumulated value. The time distribution of an output accumulated value is created by accumulating the response output for detection intervals. The processor is further configured to output data of the distance according to a specific divided period. The specific divided period is specified based on the time distribution of the output accumulated value. The specific divided period is one of divided periods which are portions of a sampling interval each having a length of the delay interval. The specific divided period includes a response start timing of the SPAD pixel corresponding to the reference light.

A second aspect of the present disclosure includes an optical sensor configured to detect a distance to a target by receiving reflected lights, which are irradiation lights by light emission, from the target with a SPAD pixel, and the controller of the first aspect.

According to a third aspect of the present disclosure, a control method executed by a processor for controlling an optical sensor configured to detect a distance to a target by receiving reflected lights from the target with a SPAD pixel is provided. The reflected lights are irradiation lights by light emission. The control method includes controlling the irradiation lights to be emitted respectively in each of detection intervals. The irradiation lights include reference light and multiple types of delayed lights for each detection frame. The reference light is emitted at a start timing of a detection interval. The multiple types of delayed lights are emitted with delays from start timings of detection intervals and different in delay by a delay interval from each other. Each of the detection intervals is a duration during which response output of the SPAD pixel is repeatedly sampled at sampling intervals. Each of the sampling intervals is greater than the delay interval. The method further includes obtaining time distribution of an output accumulated value for each detection frame. The time distribution of the output accumulated value is created by accumulating the response output for detection intervals. The method further includes specifying a specific divided period based on the time distribution of the output accumulated value. The specific divided period is specified based on the time distribution of the output accumulated value. The specific divided period is one of divided periods which are portions of a sampling interval each having a length of the delay interval. The specific divided period includes a response start timing of the SPAD pixel corresponding to the reference light. The method further includes outputting data of the distance according to the specific divided period.

According to a fourth aspect of the present disclosure, a computer-readable storage medium storing a control program that includes instructions to be executed by a processor to control an optical sensor is provided. The optical sensor is configured to detect a distance to a target by receiving reflected lights from the target with a SPAD pixel. The reflected lights are irradiation lights by light emission. The instructions, when executed by the processor, cause the processor to control the irradiation lights to be emitted respectively in each of detection intervals. The irradiation lights include reference light and multiple types of delayed lights for each detection frame. The reference light is emitted at a start timing of a detection interval. The multiple types of delayed lights are emitted with delays from start timings of detection intervals and different in delay by a delay interval from each other. Each of the detection intervals is a duration during which response output of the SPAD pixel is repeatedly sampled at sampling intervals. Each of the sampling intervals is greater than the delay interval. Each detection frame is a duration for obtaining time distribution of an output accumulated value. The time distribution of an output accumulated value is created by accumulating the response output for detection intervals. The instructions further cause the processor to output data of the distance according to a specific divided period. The specific divided period is specified based on the time distribution of the output accumulated value. The specific divided period is one of divided periods which are portions of a sampling interval each having a length of the delay interval. The specific divided period includes a response start timing of the SPAD pixel corresponding to the reference light.

### BRIEF DESCRIPTION OF THE DRAWINGS

FIG. 1 is a block diagram illustrating the overall configuration of an optical detection system according to one embodiment.

FIG. 2 is a schematic diagram illustrating the physical configuration of an optical sensor according to one embodiment.

FIG. 3 is a block diagram illustrating the functional configuration of the optical detection system according to one embodiment.

FIG. 4 is a schematic diagram of a light projector according to one embodiment.

FIG. 5 is a graph for explaining a detection frame according to one embodiment.

FIG. 6 is a schematic diagram of a light receiver according to one embodiment.

FIG. 7 is a block diagram illustrating an example of the configuration of a SPAD pixel according to one embodiment.

FIG. 8 is a block diagram illustrating another example of the configuration of a SPAD pixel according to one embodiment.

FIG. 9 is a graph for explaining a control flow according to one embodiment.

FIG. 10 is a graph for explaining the control flow according to one embodiment.

FIG. 11 is a graph for explaining the control flow according to one embodiment.

FIG. 12 is a graph for explaining the control flow according to one embodiment.

FIG. 13 is a graph for explaining the control flow according to one embodiment.

FIG. 14 is a flowchart illustrating the control flow according to one embodiment.

FIG. 15 is a graph for explaining the control flow according to one embodiment.

FIG. 16 is a graph for explaining the control flow according to one embodiment.

FIG. 17 is a graph for explaining the control flow according to one embodiment.

FIG. 18 is a graph for explaining the control flow according to one embodiment.

FIG. 19 is a table for explaining the control flow according to one embodiment.

FIG. 20 is a graph for explaining the control flow according to one embodiment.

FIG. 21 is a graph for explaining the control flow according to one embodiment.

FIG. 22 is a graph for explaining the control flow according to one embodiment.

FIG. 23 is a graph for explaining the control flow according to one embodiment.

FIG. 24 is a graph for explaining the control flow according to one embodiment.

FIG. 25 is a graph for explaining the control flow according to one embodiment.

FIG. 26 is a graph for explaining the control flow according to one embodiment.

FIG. 27 is a graph for explaining the control flow according to one embodiment.

FIG. 28 is a graph for explaining the control flow according to one embodiment.

FIG. 29 is a graph for explaining the control flow according to one embodiment.

### DESCRIPTION OF EMBODIMENτs

To begin with, examples of relevant techniques will be described.

Optical sensors that detect the distance to a target by using Single Photon Avalanche Diode (i.e., SPAD) pixels to receive reflected light that is emitted by illumination and reflected by the target have been attracting attention. In one technique for controlling this type of optical sensor, the distance is detected by creating a histogram. The histogram is created by repeatedly sampling outputs of SPAD pixels that have responded within a detection frame, and accumulating the outputs. In the technique described above, the time resolution is changed between high and low by adjusting the sampling frequency. Specifically, the distance is detected based on a histogram obtained by re-sampling a range identified by sampling at a low time resolution with a high time resolution.

In the technology described above, distance resolution can be ensured according to the higher time resolution. However, the frame rate is limited since sampling is performed repeatedly in two-stage for each detection frame. Thus, there is a limit on the final distance detection accuracy.

One example of the present disclosure provides a controller configured to improve distance detection accuracy by an optical sensor. Another example of the present disclosure provides an optical detection system configured to improve distance detection accuracy by an optical sensor. Yet another example of the present disclosure provides a control method for improving distance detection accuracy by an optical sensor. Further, another example of the present disclosure provides a storage medium storing a control program for improving distance detection accuracy by an optical sensor.

Hereinafter, technical means of the present disclosure for solving the issues will be described.

According to a first aspect of the present disclosure, a controller configured to control an optical sensor is provided. The optical sensor is configured to detect a distance to a target by receiving reflected lights from the target with a SPAD pixel. The reflected lights are irradiation lights emitted by illumination. The controller includes a processor. The processor is configured to control the irradiation lights to be emitted respectively in each of detection intervals. The irradiation lights include reference light and multiple types of delayed lights for each detection frame. The reference light is emitted at a start timing of a detection interval. The multiple types of delayed lights are emitted with delays from start timings of detection intervals and different in delay by a delay interval from each other. Each of the detection intervals is a duration during which response output of the SPAD pixel is repeatedly sampled at sampling intervals. Each of the sampling intervals is greater than the delay interval. Each detection frame is a duration during which the response output is accumulated for detection intervals to obtain time distribution of an output accumulated value. The processor is further configured to output data of the distance according to a specific divided period. The specific divided period is specified based on the time distribution of the output accumulated value. The specific divided period is one of divided periods which are portions of a sampling interval each having a length of the delay interval. The specific divided period includes a response start timing of the SPAD pixel corresponding to the reference light.

A second aspect of the present disclosure includes an optical sensor configured to detect a distance to a target by receiving reflected lights, which are irradiation lights emitted by illumination, from the target with a SPAD pixel, and the controller of the first aspect.

According to a third aspect of the present disclosure, a control method executed by a processor for controlling an optical sensor configured to detect a distance to a target by receiving reflected lights from the target with a SPAD pixel is provided. The reflected lights are irradiation lights emitted by illumination. The control method includes controlling the irradiation lights to be emitted respectively in each of detection intervals. The irradiation lights include reference light and multiple types of delayed lights for each detection frame. The reference light is emitted at a start timing of a detection interval. The multiple types of delayed lights are emitted with delays from start timings of detection intervals and different in delay by a delay interval from each other. Each of the detection intervals is a duration during which response output of the SPAD pixel is repeatedly sampled at sampling intervals. Each of the sampling intervals is greater than the delay interval. Each detection frame is a duration during which the response output is accumulated for detection intervals to obtain time distribution of an output accumulated value. The method further includes outputting data of the distance according to a specific divided period. The specific divided period is specified based on the time distribution of the output accumulated value. The specific divided period is one of divided periods which are portions of a sampling interval each having a length of the delay interval. The specific divided period includes a response start timing of the SPAD pixel corresponding to the reference light.

According to a fourth aspect of the present disclosure, a storage medium storing a control program that includes instructions to be executed by a processor to control an optical sensor is provided. The optical sensor is configured to detect a distance to a target by receiving reflected lights from the target with a SPAD pixel. The reflected lights are irradiation lights emitted by illumination. The instructions, when executed by the processor, cause the processor to control the irradiation lights to be emitted respectively in each of detection intervals. The irradiation lights include reference light and multiple types of delayed lights for each detection frame. The reference light is emitted at a start timing of a detection interval. The multiple types of delayed lights are emitted with delays from start timings of detection intervals and different in delay by a delay interval from each other. Each of the detection intervals is a duration during which response output of the SPAD pixel is repeatedly sampled at sampling intervals. Each of the sampling intervals is greater than the delay interval. Each detection frame is a duration during which the response output is accumulated for detection intervals to obtain time distribution of an output accumulated value. The instructions further cause the processor to output data of the distance according to a specific divided period. The specific divided period is specified based on the time distribution of the output accumulated value. The specific divided period is one of divided periods which are portions of a sampling interval each having a length of the delay interval. The specific divided period includes a response start timing of the SPAD pixel corresponding to the reference light.

In the first to fourth aspects, the irradiation lights are controlled for each detection frame in which a time distribution of the output accumulation value is obtained by repeatedly sampling the response output of the SPAD pixel at sampling intervals, and accumulating the response output for detection intervals. The irradiation lights include reference light and multiple types of delayed lights. The reference light is emitted at a start timing of a detection interval. The multiple types of delayed lights are emitted with delays from start timings of detection intervals and different in delay by a delay interval from each other. The delay interval is less than a sampling interval. Thus, the output accumulation value of the SPAD pixel corresponding to the reference light and the multiple types of delayed light is obtained for each detection frame.

According to the first to fourth aspects, the divided periods are portions of the sampling interval, and each of the divided periods has a length of the delay interval. The specific divided period is one of the divided periods that includes a response start timing of the SPAD pixel corresponding to the reference light. The divided periods including response start timings of the SPAD pixel corresponding to the multiple types of delayed light are shifted from the specific divided period including the response start timing of the SPAD pixel corresponding to the reference light by the delayed interval from each other. Thus, whether the divided period including the response start timing of the SPAD pixel corresponding to each delayed light falls within the same sampling interval as the divided period including the response start timing to the reference light depends on the distance to the target. Thus, the time distribution of the output accumulation value may change depending on the distance to the target.

According to the first to fourth aspects, the specific divided period, which is a divided period including the response start timing to the reference light, is specified from the time distribution of the output accumulation value, and the distance is output according to the specific divided period as data. Thus, the distance resolution can be improved in accordance with the divided period which is less than a sampling interval. Moreover, the frame rate can be increased since the data of the distance is output by repeating the above-mentioned one-stage sampling process for each detection frame. As described above, it is possible to achieve both high distance resolution and a high frame rate, thereby realizing high distance detection accuracy.

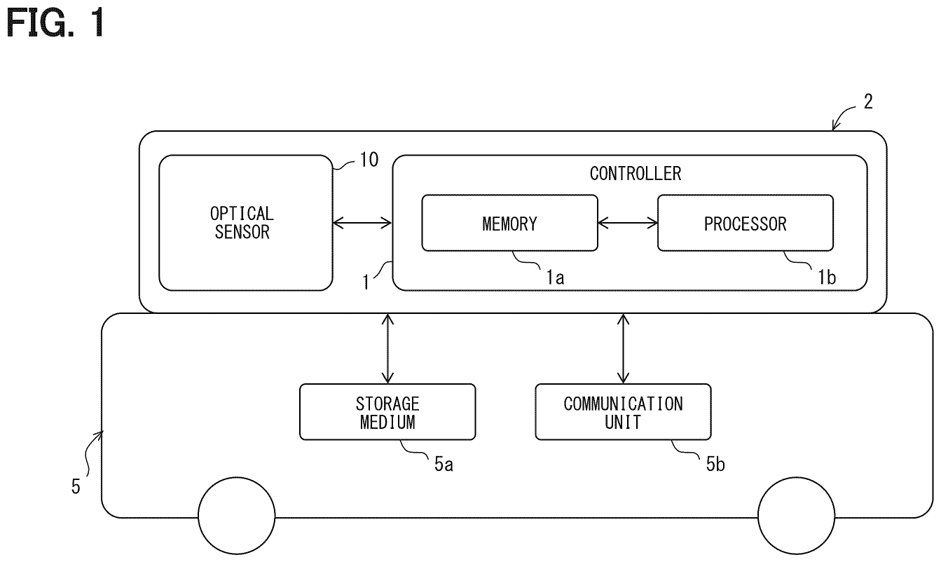

As shown in FIG. 1, one embodiment of the present disclosure relates to an optical detection system 2 that includes an optical sensor 10 and a controller 1. The optical detection system 2 is mounted on a vehicle 5 as a mobile object. The vehicle 5 is a mobile body such as an automobile that can travel on a traveling path while an occupant is on the vehicle 5.

The vehicle 5 is capable of executing a constant or temporary automated traveling in an automated driving control mode. Here, the automated driving control mode may be achieved with an autonomous operation control, such as conditional driving automation, advanced driving automation, or full driving automation, where the system in operation performs all driving tasks. The automated driving control mode may be achieved with an advanced driving assistance control, such as driving assistance or partial driving automation, where the occupant performs some or all driving tasks. The automated driving control mode may be achieved by any one, combination, or switching of autonomous driving control and advanced driving assistance control.

In the following description, unless otherwise specified, directions of the front, the rear, the top, the bottom, the left, and the right are defined with respect to the vehicle 5 on a horizontal plane. Further, a horizontal direction refers to a parallel direction with respect to a horizontal plane that serves as a direction reference for the vehicle 5. Furthermore, a vertical direction refers to a direction perpendicular to a horizontal plane serving as a direction reference for the vehicle 5.

The optical sensor 10 is a so-called Light Detection and Ranging/Laser Imaging Detection and Ranging (i.e., LiDAR) for acquiring data that can be used for driving control of the vehicle 5 with the automated control driving mode. The optical sensor 10 is disposed in at least one of a front portion, a left side portion, a right side portion, a rear portion, or an upper roof of the vehicle 5.

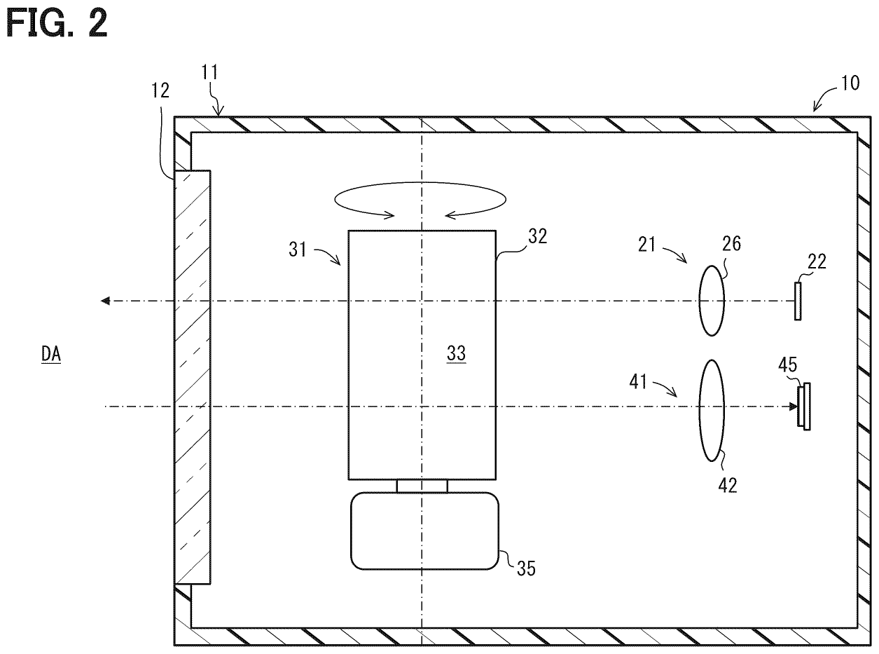

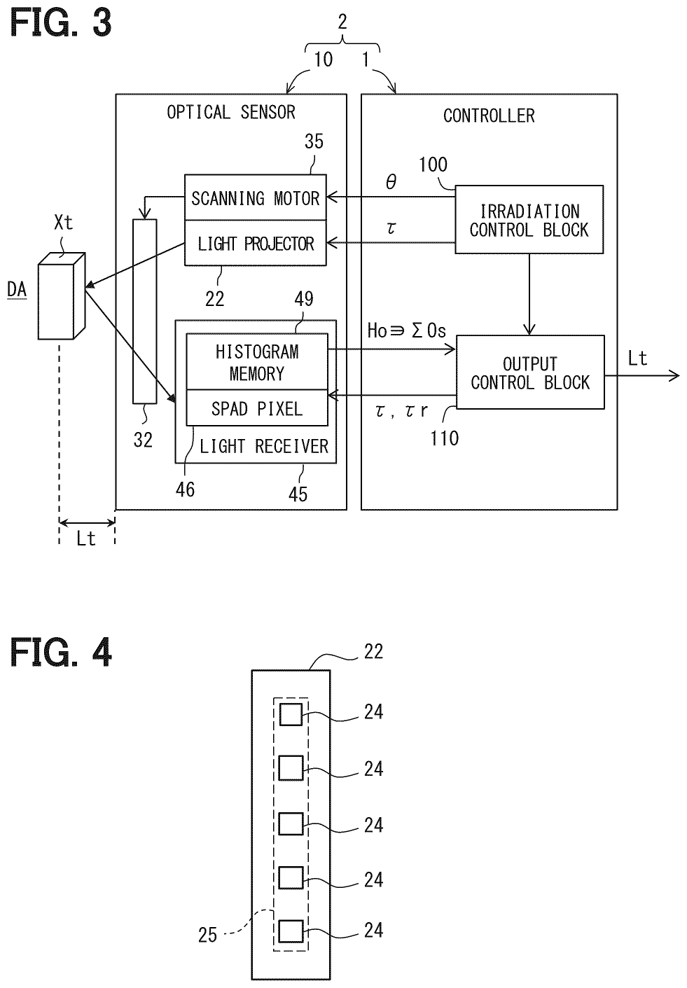

As shown in FIGS. 2 and 3, the optical sensor 10 emits light toward a detection area DA in the external space of the vehicle 5. The detection area DA depends on an arrangement and a viewing angle of the optical sensor 10. The optical sensor 10 receives reflected light that is emitted as irradiation light, reflected in the detection area DA, and then enters the optical sensor 10. In response to receiving the reflected light, the optical sensor 10 detects a target Xt that reflects the light within the detection area DA. Here, detection in this embodiment means sensing the distance Lt to the target Xt from the optical sensor 10, as diagrammatically shown in FIG. 3.

The target Xt of the optical sensor 10 that is applied for a vehicle 5 may be one type of moving objects such as a pedestrian, a cyclist, an animal other than a human, and another vehicle. The target Xt of the optical sensor 10 that is applied for a vehicle 5 may be one type of stationary objects such as a guardrail, a road sign, a structure on a roadside, and a dropped object on a road.

As shown in FIG. 2, the optical sensor 10 includes a housing 11, a light projection unit 21, a scanning unit 31, and a light receiving unit 41. The housing 11 is formed in a box shape and has light blocking properties. The housing 11 accommodates the light projection unit 21, the scanning unit 31, and the light receiving unit 41 therein. The housing 11 has a light-transmitting cover panel 12. In FIG. 2, the left part with respect to the dashed-dot line (i.e., a part between the cover panel 12 and the dashed-dot line) is actually a cross section perpendicular to the right part with respect to the dashed-dot line (i.e., a part on a side of the dashed-dot line toward the units 21 and 41).

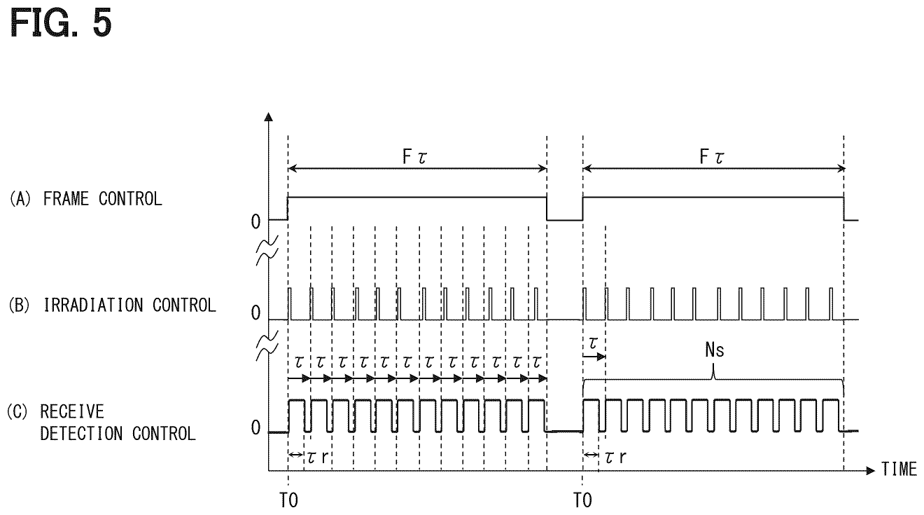

As shown in FIGS. 2 and 3, the light projection unit 21 includes a light projector 22 and an irradiation optical system 26. The light projector 22 is composed of multiple laser diodes 24 arranged in the vertical direction as shown in FIG. 4. Each of the laser diodes 24 may be an edge-emitter laser or a vertical cavity surface emitting laser (i.e., VCSEL). In particular, each of the laser diodes 24 emits light in the near-infrared range that is invisible for humans in the external space of the vehicle 5 including the detection area DA. The light emission of each of the laser diodes 24 is executed as a pulse emission according to a control signal from the controller 1 each time a detection interval T is repeated. The detection interval T is repeated a set number of times (i.e., a total accumulation count Ns which will be described later) for each detection frame FT shown in FIG. 5.

As shown in FIG. 4, the light projector 22 has a light projection window 25 formed on one side of a substrate of the light projector 22. The light projection window 25 is pseudo-defined to have a rectangular outline, with the long side oriented along the vertical direction. The light projection window 25 is designed as a collection of projection apertures of the laser diodes 24. The light emitted through the projection apertures of the laser diodes 24 is projected from the light projection window 25 as longitudinal linear irradiation light along the vertical direction in the detection area DA. The irradiation light may include a non-light emission portion corresponding to the arrangement distance between the laser diodes 24 in the vertical direction. Even in this case, it is preferable to form linear irradiation light, where the non-light emission portion is macroscopically eliminated in the vertical direction due to diffraction effect.

As shown in FIG. 2, the irradiation optical system 26 guides the irradiation light by light emission in the light projector 22 toward a scanning mirror 32 of the scanning unit 31. The irradiation optical system 26 has at least one optical lens to provide at least one type of optical function among, for example, condensing, collimating, and shaping.

As shown in FIGS. 2 and 3, the scanning unit 31 includes the scanning mirror 32 and a scanning motor 35. The scanning mirror 32 has a plate shape. One surface of the base material of the scanning mirror 32 is a reflective surface 33 on which a reflective layer is vapor deposited. The scanning mirror 32 is rotatably supported by the housing 11 around a rotational centerline oriented in the vertical direction. The scanning mirror 32 swings within an operation range limited by a mechanical or electrical stopper. The scanning motor 35 rotates (i.e., swings) the scanning mirror 32 within a finite operation range. At this time, the rotational angle of the scanning mirror 32 changes sequentially during each detection frame FT (see FIG. 5) in accordance with a control signal from the controller 1.

The scanning mirror 32 reflects the irradiation light that enters from the irradiation optical system 26 of the light projection unit 21 by the reflective surface 33 toward the detection area DA through the cover panel 12, thereby scanning the area DA according to the rotational angle of the scanning motor 35. In this embodiment, mechanical scanning of the detection area DA by the irradiation light is substantially limited in the horizontal direction.

The scanning mirror 32 reflects the reflected light that enters from the detection area DA through the cover panel 12 in accordance with the rotational angle of the scanning motor 35 toward the light receiving unit 41 by the reflective surface 33. Here, the speeds of the irradiation light and the reflected light are sufficiently large relative to the rotational speed of the scanning mirror 32. Thus, the reflected light of the irradiation light is further reflected to the light receiving unit 41 at the scanning mirror 32 having substantially the same rotational angle as the rotational angle for the irradiation light. At this time, the direction of the reflected light is opposite to the direction of the irradiation light.

The light receiving unit 41 includes the light receiving optical system 42 and a light receiver 45. The light receiving optical system 42 is positioned vertically offset from the irradiation optical system 26. The light receiving optical system 42 guides the reflected light incident from the scanning mirror 32 toward the light receiver 45. The light receiving optical system 42 includes at least one optical lens for imaging the reflected light onto the light receiver 45.

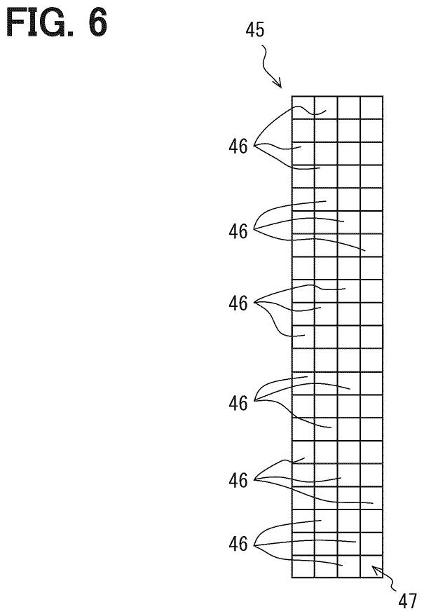

The light receiver 45 receives the reflected light from the detection area DA, which is imaged by the light receiving optical system 42, and generates an output according to the distance Lt to the target Xt. For this purpose, the light receiver 45 has a light receiving surface 47 on the substrate. The light receiving surface 47 has a rectangular outline with its longer sides aligned vertically as shown in FIG. 6. The reflected light from the target Xt in response to the irradiation light is incident on the light receiving surface 47 through the light receiving optical system 42 as a linearly expanding beam. The light receiving surface 47 is designed a collection of incident surfaces of SPAD pixels 46 onto which the reflected light is incident. The SPAD pixels 46 are arranged at least along the vertical direction out of the vertical and horizontal directions.

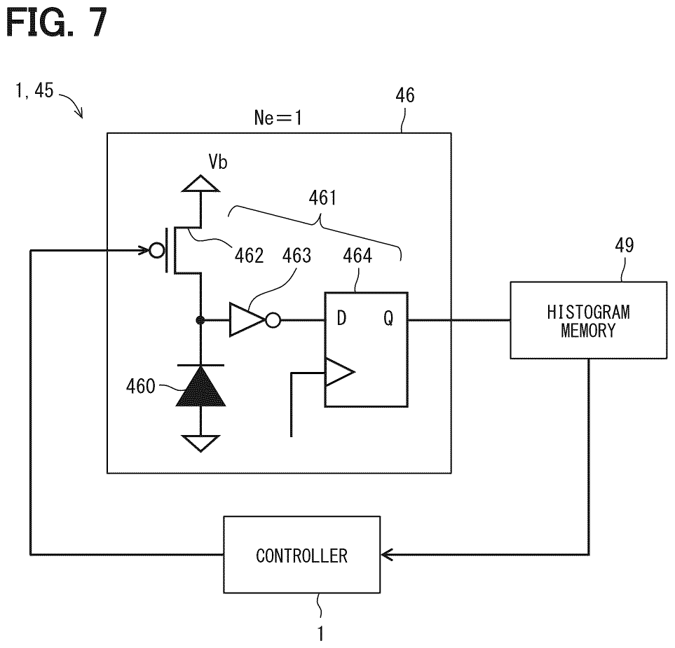

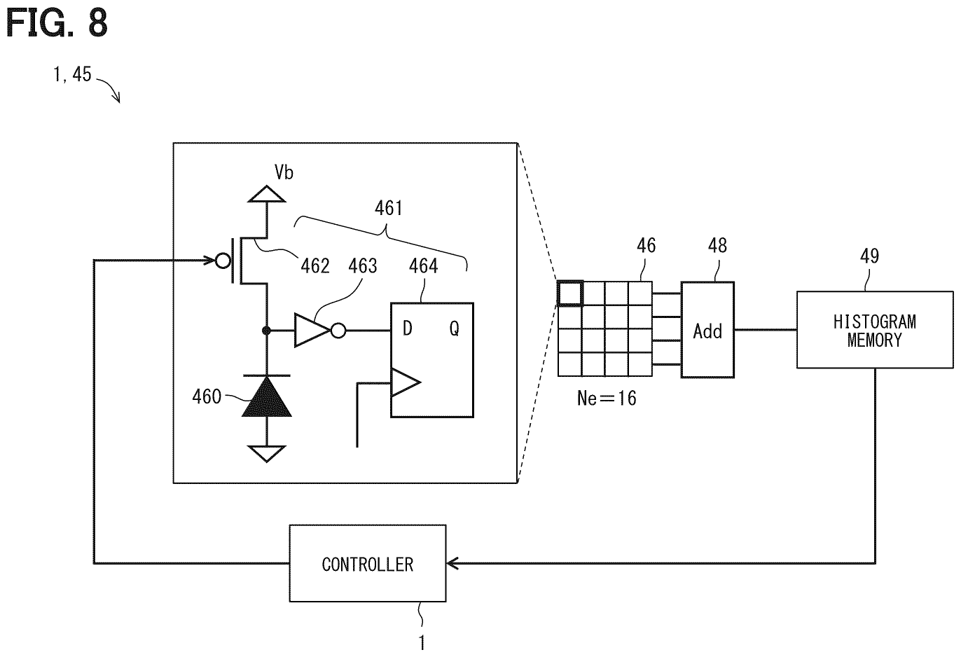

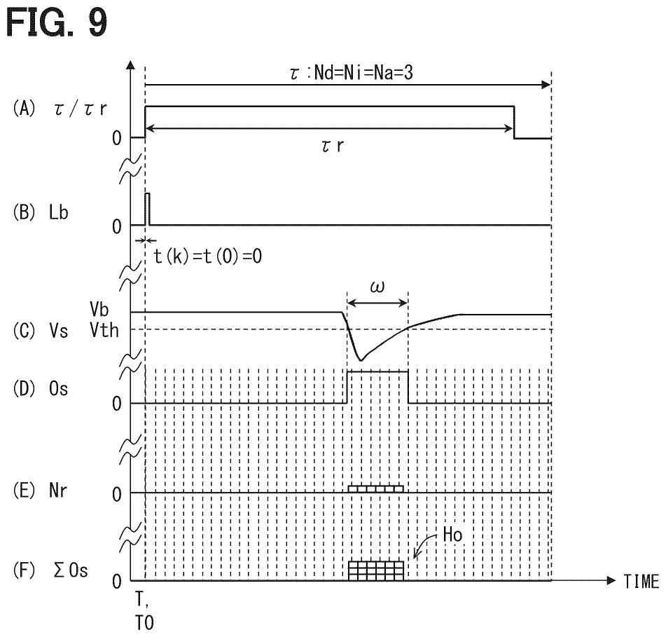

As shown in FIGS. 7 and 8, each of the SPAD pixels 46 includes at least one pair of a SPAD element 460 and a SPAD circuit 461. In the SPAD circuit 461, a bias voltage Vb is applied to the cathode of the SPAD element 460 via a switching element 462. The switching element 462 controls, in accordance with a control signal from the controller 1, a light receiving period τr during which the SPAD pixel 46 responds to the reflected light. The light receiving period τr is a period within a detection interval τ. The detection interval τ is repeated for each detection frame Fτ as shown in FIG. 5. As a result, the SPAD pixel 46 that has responded to the light outputs a SPAD voltage Vs during the light receiving period τr. The SPAD voltage Vs fluctuates based on the bias voltage Vb as shown in FIGS. 9 to 12.

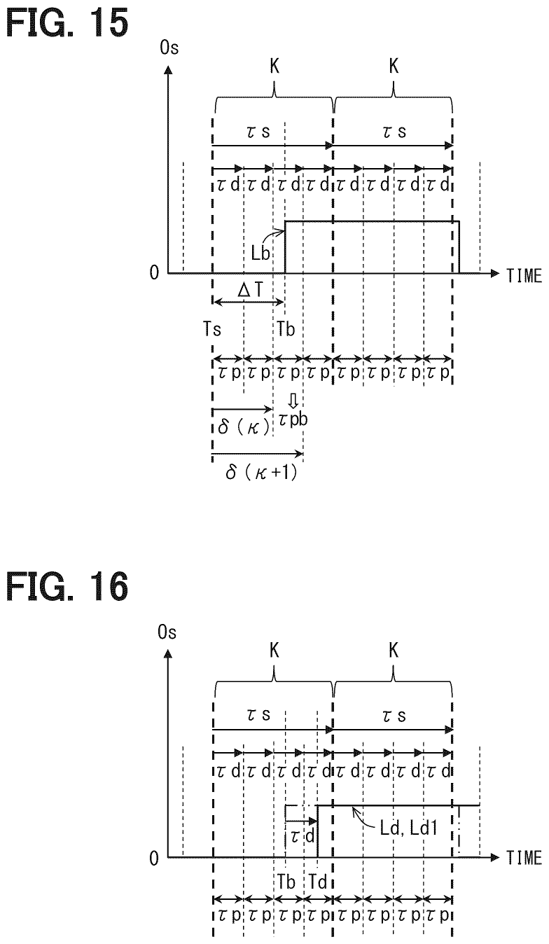

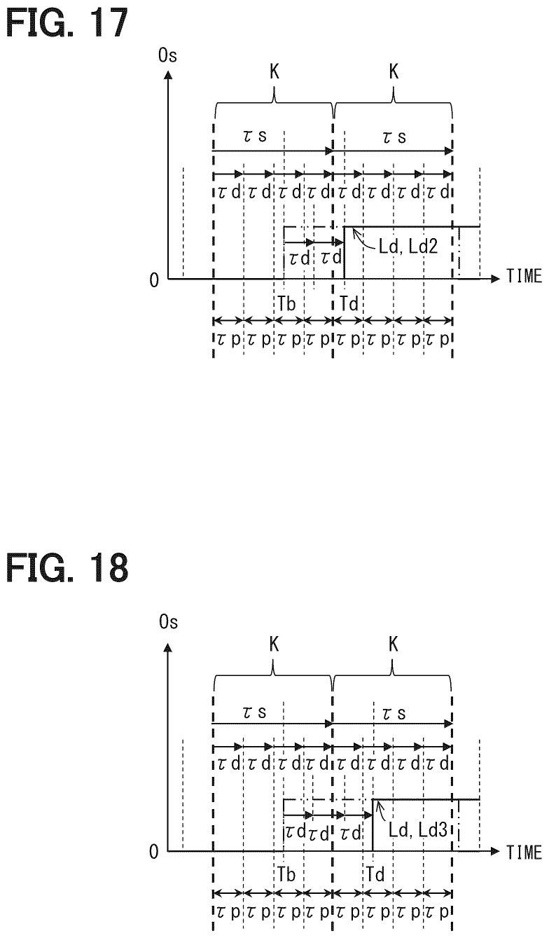

As shown in FIGS. 7 and 8, the SPAD circuit 461 includes an inverter 463 connected between the SPAD element 460 and the switching element 462. The inverter 463 outputs a pulse signal during a dead time w. The dead time w is a duration from when the SPAD voltage Vs of the responding SPAD pixel 46 is inverted to cross the threshold Vth until when the SPAD voltage Vs recovers and crosses the threshold Vth again, as shown in FIGS. 9 to 12. The pulse signal that is quantized in the amplitude direction and output from the inverter 463 is response output Os of the SPAD pixel 46. As a result, a response start timing (Tb, Td shown in FIGS. 15 to 18 described later) at which the response output Os of the SPAD pixel 46 starts is defined as the timing at which the SPAD voltage Vs crosses the threshold value Vth to the inversion side.

As shown in FIGS. 7 and 8, the inverter 463 in the SPAD circuit 461 has an output side connected to the sampling circuit 464. The sampling circuit 464 samples the response output Os during the detection interval τ, which is repeated for each detection frame FT, as shown in FIGS. 9 to 12. The repeated sampling process converts the response output Os of the SPAD pixel 46 into a digital signal value that is discretized in the time direction.

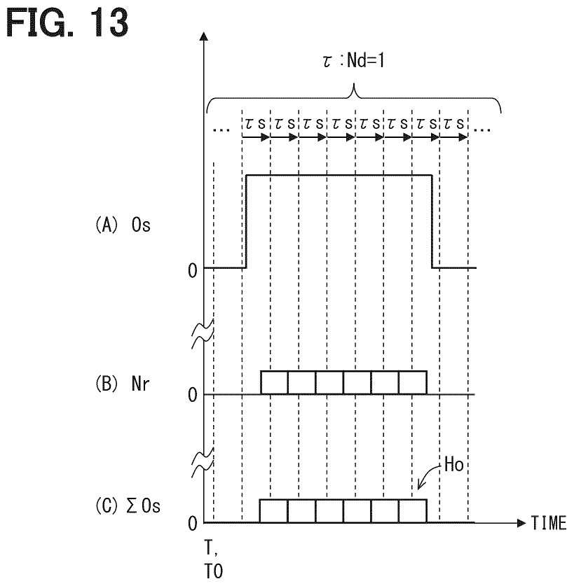

Here, in the light receiver 45 in which each SPAD pixel 46 includes a single pair of a SPAD element 460 and a SPAD circuit 461 as shown in FIG. 7, the digital signal value from the sampling circuit 464 is directly provided to the subsequent stage as the response output Os of the SPAD pixel 46. FIGS. 9 to 13 and 20 to 25 show a case, as a representative, in which the number of pairs of elements 460, 461 constituting each SPAD pixel 46 is one as shown in FIG. 7 in order to simplify the explanation.

On the other hand, in the light receiver 45 in which each SPAD pixel 46 includes multiple pairs of the SPAD element 460 and the SPAD circuit 461 as shown in FIG. 8, the digital signal values from the sampling circuits 464 in the SPAD pixel 46 are added for the multiple pairs by an individual adder 48 for each of the SPAD pixel 46. Here, FIG. 8 diagrammatically shows multiple pairs of the elements 460 and 461 (FIG. 8 shows an example of 16 pairs) by multiple lattices of a single SPAD pixel 46. In the multiple-pair light receiver 45 as shown in FIG. 8, the sum by the adder 48 is provided to the subsequent stage as the response output Os of the SPAD pixel 46.

As shown in FIGS. 3, 7 and 8, the light receiver 45 is provided with a histogram memory 49 for each SPAD pixel 46. The histogram memory 49 counts the digital signal value or its sum, which is the response output Os of the corresponding SPAD pixel 46, each time a sampling interval τs is repeated during each detection interval τ for each detection frame FT, as shown in FIGS. 9 to 13. The sampling interval τs is a period between the dashed lines in FIGS. 9 to 12. From the viewpoint of the entire light receiver 45, the count value means the number of SPAD pixels 46 which have responded within one sampling interval τs. That is, the count value means the response count Nr.

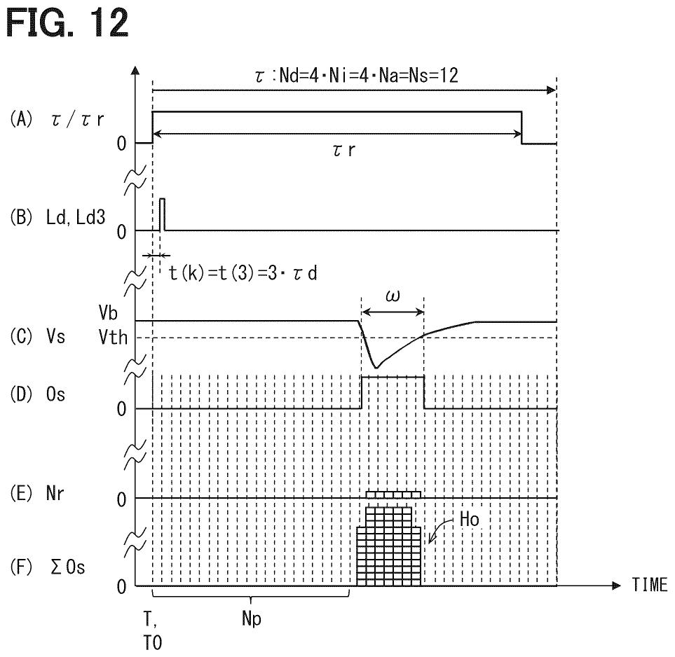

For each SPAD pixel 46, the histogram memory 49 acquires and stores an output accumulated value ΣOs. The output accumulated value ΣOs is obtained by accumulating the count value of the response output Os for a total accumulation count Ns (see FIGS. 5 and 12). The total accumulation count Ns is a number of the detection intervals T, for each detection frame FT. As shown in FIGS. 9 to 13, the time distribution of the output accumulated value ΣOs is obtained as a histogram Ho by stacking the count values of the response output Os for the detection intervals τ. In this stacking (accumulation), the start timings T of the detection intervals τ are aligned. The obtained histogram Ho is stored in the histogram memory 49.

The histogram Ho of the output accumulated value ΣOs stored in the histogram memory 49 for each SPAD pixel 46 is read out by the controller 1 for each detection frame Fτ as shown in FIG. 3, and is used to output data on the distance Lt to the target Xt. In FIGS. 9 to 13 and 20 to 25, the response output Os, the response count Nr as a count value, and the output accumulated value ΣOs are diagrammatically shown by rectangular blocks corresponding to the end timing of each sampling interval τs.

The controller 1 shown in FIGS. 1, 3, 7, and 8 is connected to the optical sensor 10 through at least one of a Local Area Network (LAN), a wire harness, and an internal bus. The controller 1 includes at least one dedicated computer. The dedicated computer constituting the controller 1 may be a sensor Electronic Control Unit (ECU) specialized for controlling the optical sensor 10. In this case, the sensor ECU may be housed in the housing 11. The dedicated computer constituting the controller 1 may be a driving control ECU that controls the driving of the vehicle 5.

As shown in FIG. 1, the dedicated computer constituting the controller 1 includes at least one memory 1a and at least one processor 1b. The memory 1a is at least one type of non-transitory tangible storage medium out of, for example, a semiconductor memory, a magnetic medium, an optical medium, and the like that non-transitorily store a computer readable program, data, and the like. For example, the processor 1b may include, as a core, at least one of a central processing unit (CPU), a graphics processing unit (GPU), a reduced instruction set computer (RISC) CPU, a data flow processor (DFP), a graph streaming processor (GSP).

The processor 1b executes multiple instructions included in a control program stored in the memory 1a. Thereby, the controller 1 constructs multiple functional blocks for controlling the optical sensor 10. In this manner, in the controller 1, the control program stored in the memory 1a for controlling the optical sensor 10 causes the processor 1b to execute instructions, thereby constructing the functional blocks. The functional blocks constructed by the controller 1 include an irradiation control block 100 and an output control block 110 as shown in FIG. 3.

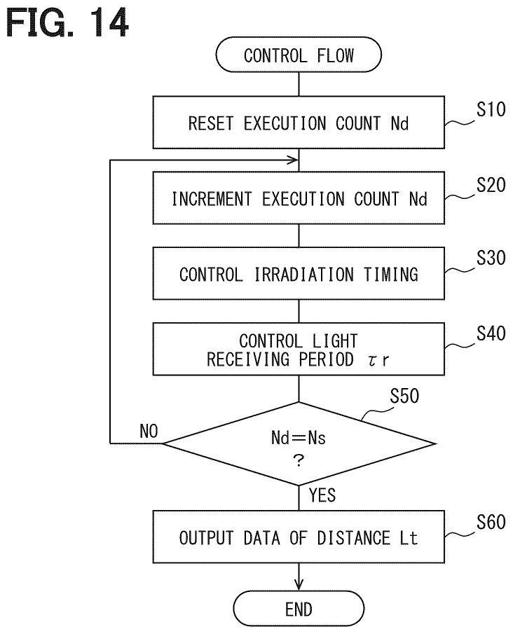

The control method in which the controller 1 controls the optical sensor 10 with the blocks 100 and 110 is executed according to the control flow shown in FIG. 14. This control flow is repeatedly executed for each detection frame Fτ while the vehicle 5 is activated. Each “S” in the control flow indicates one or more processes executed by one or more instructions included in the control program.

In S10 of the control flow, the irradiation control block 100 resets an execution count Nd of the detection intervals τ in the current detection frame Fτ to zero. The execution count Nd is the number of the detection intervals τ that have been executed in the current detection frame Fτ. In S20 of the control flow, the irradiation control block 100 increments the execution count Nd of the detection intervals τ by one and sets the obtained value as a current value (i.e., current execution count Nd).

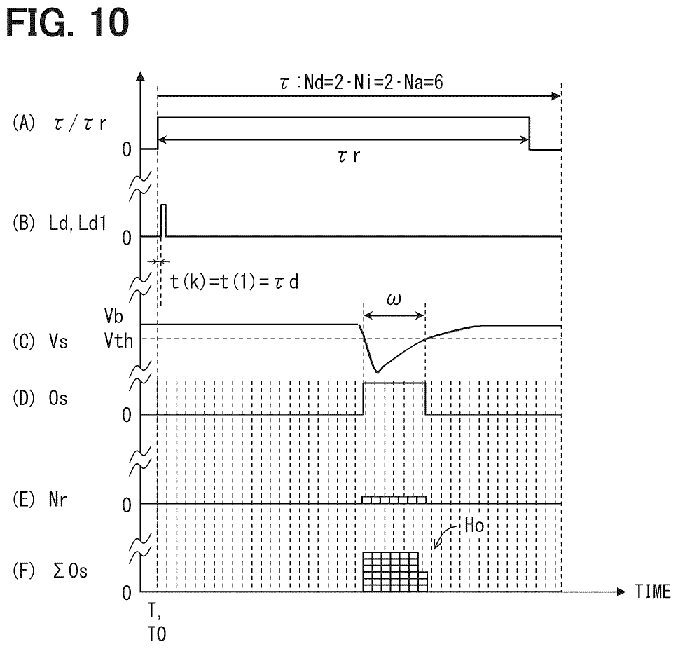

In S30 of the control flow, the irradiation control block 100 controls the irradiation timing of the pulse irradiation light from the light projector 22 to the timing corresponding to the detection interval τ of the current value (see FIGS. 3 and 9 to 12). Specifically, in S30, the irradiation control block 100 controls, as irradiation light, a single type of reference light Lb and multiple types of delayed lights. The irradiation timing of the reference light Lb is controlled to be aligned at the start timing T of the detection interval τ as shown in FIG. 9. The multiple types of delayed lights are controlled to be delayed from the start timing T. The multiple types of delayed lights are different in delay by a delay interval Td from each other as shown in FIGS. 10 to 12.

The irradiation control block 100 in S30 determines the delay interval Td to be less than the sampling interval τs according to the following Equation 1. K in the Equation 1 is a magnification value of the distance resolution increased by this embodiment with respect to the normal distance resolution corresponding to the sampling interval τs. The magnification value K in this embodiment coincides with the number of divided periods τp in one sampling interval τs. The divided periods τp are portions of a sampling interval τs as shown in FIGS. 15 to 18. The magnification value K in this embodiment coincides with the total number of types of irradiation light, which is the sum of the number of types of reference light Lb and the number of types of delayed light Ld.

$$τ d = τ s / K \qquad ( Equation 1 )$$

The irradiation control block 100 in S30 controls a delayed control time t(k) in accordance with the following Equation 2 using the delay interval τd of Equation 1, as shown in FIGS. 9 to 12. The delayed control time t(k) is a duration from the start timing T of the detection interval τ to the irradiation timing of each irradiation light. In Equation 2, k is set to an integer from 0 to K−1 as an alphabetical index for the types of irradiation light. Here, in the case of K=4, FIG. 9 shows an example of k=0. In this example, the delayed control time t(k)=0 according to Equation 2. That is, k=0 represents the reference light Lb whose irradiation timing coincides with the start timing T of the detection interval τ.

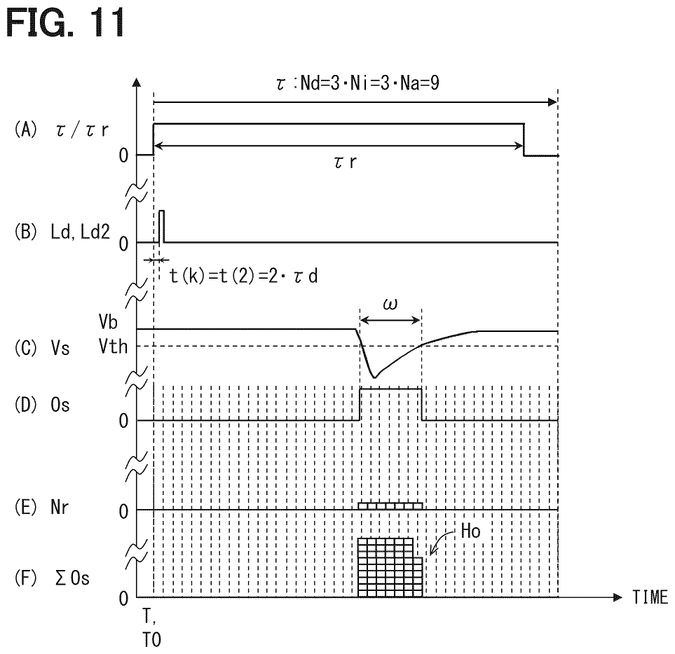

On the other hand, k=1 to K−1 in Equation 2 represent multiple types of delayed light Ld having different delayed control times t(k) by which the irradiation timing is delayed from the start timing T of the detection interval τ. In particular, k=1 in the case of K=4 shown in FIG. 10 represents a first delayed light Ld1, among the multiple types of delayed light Ld, whose delayed control time t(k) is controlled to τd in accordance with the Equation 2. Additionally, k=2 in the case of K=4 shown in FIG. 11 represents a second delayed light Ld2, among the multiple types of delayed light Ld, whose delayed control time t(k) is controlled to 2τd in accordance with the Equation 2. Furthermore, k=3 in the case of K=4 shown in FIG. 12 represents a third delayed light Ld3, among the multiple types of delayed light Ld, whose delayed control time t(k) is controlled to 3τd in accordance with the Equation 2.

$$t ( k ) = k \cdot τ d = k \cdot τ s / K \qquad ( Equation 2 )$$

The irradiation control block 100 in S30 controls the delayed control time t(k) for any type of delayed lights Ld1, Ld2, Ld3 corresponding to k=1 to K−1 to be less than the dead time w of the SPAD pixel 46 in accordance with the following Equation 3. In the case that the maximum delayed control time t(K−1) for k=K−1 satisfies the Equation 3, the other delayed control times t(k) will necessarily satisfy the Equation 3 as well.

$$t ( k ) < ω \qquad ( Equation 3 )$$

As shown in FIGS. 9 to 12, the irradiation control block 100 in S30 controls an individual irradiation count Ni for each type of irradiation light corresponding to k=0 to K−1, ensuring the individual irradiation count Ni is a common number of times (three times each in the examples of FIGS. 9 to 12) according to the following Equation 4. The individual irradiation count Ni is in other words the number of times each type of irradiation light is sequentially emitted. In this case, the reference light Lb, the first delayed light Ld1, the second delayed light Ld2 and the third delayed light Ld3 are controlled to be emitted for the individual irradiation counts Ni in this order. However, the emission order of the different types of irradiation light may be changed as long as each type of irradiation light is emitted for the individual irradiation count Ni during the detection frame Fτ.

$$Ni = Ns / K = Na \qquad ( Equation 4 ] )$$

The irradiation control block 100 in S30 controls the rotational angle of the scanning mirror 32 to an angle θ corresponding to the detection interval τ of the current execution count Nd (see FIG. 3). For example, each detection interval τ has a length of 2000 ns in the current detection frame Fτ. In this case, it is possible to assume that the rotational angle of the scanning mirror 32 is substantially the same for each detection interval τ. Thus, in other words, the rotational angle of the scanning mirror 32 is controlled to an angle corresponding to the current detection frame Fτ in S30.

As shown in FIG. 14, in S40 of the control flow, the output control block 110 controls the start timing of the light receiving period τr for each SPAD pixel 46 in the detection interval τ in the current execution count Nd, to coincide with the start timing T of the detection interval τ at which the irradiation control block 100 starts emitting irradiation light (see FIGS. 3, 9 to 12). In this case, the light receiving period τr starts based on a control signal that triggers the irradiation control in S30, and have a certain duration that is not substantially dependent on the execution count Nd. As a result, in S40 as shown in FIGS. 9 to 13, the histogram Ho of the output accumulated value ΣOs, which is obtained by accumulating the response output Os of each SPAD pixel 46 for the detection intervals τ up to the current execution count Nd, is stored in the histogram memory 49 for each SPAD pixel 46.

An individual accumulation count Na is defined as the number of response output being accumulated for each type of irradiation light. The individual accumulation count Na, out of the total accumulation count Ns of the response output accumulated in the current detection frame Fτ, coincides with the individual irradiation count Ni as shown in FIGS. 9 to 12 and the above Equation 4. That is, the individual accumulation count Na is common between the reference light Lb and multiple types of delayed light Ld1, Ld2, Ld3. Furthermore, in S40, the histogram Ho is stored in the histogram memory 49 as a time distribution of the output accumulated value ΣOs, which is obtained by accumulating the response count Nr of the SPAD pixels 46 for multiple types of irradiation light.

As shown in FIG. 14, in S50 of the control flow, the output control block 110 determines whether the execution count Nd of the detection intervals τ in which the light receiving period τr is controlled has reached the total accumulation count Ns of the response output Os. When a negative determination is made (see FIGS. 9 to 11 and 13), the control flow returns to S20. When a positive determination is made (see FIG. 12), the control flow proceeds to S60.

In S60 of the control flow, the output control block 110 obtains the histogram Ho of the output accumulated value ΣOs, which spans all detection intervals τ, from the histogram memory 49 for each SPAD pixels 46 (see FIGS. 3, 12 and 21 to 25). The all detection intervals τ mean detection intervals τ for the total accumulation count Ns. The output control block 110 in S60 outputs data of the detection result of the distance Lt to the target Xt, based on the histogram Ho of the output accumulated value ΣOs for each SPAD pixel 46 (see FIG. 3).

Specifically, the output control block 110 in S60 assumes divided periods τp. The divided periods are portions of a sampling interval that is repeated in the detection interval τ, as shown in FIGS. 15 to 18. Each of the divided periods has a length of the delay interval τd. For example, a sampling interval τs of 1 ns is subdivided with delay intervals τd of 0.25 ns, so that the number of divided periods τp within the same sampling interval τs is equal to the magnification value K of the expected distance resolution (K=4 in examples shown in FIGS. 15 to 18).

Under such assumption, in the sampling interval τs in which the response start timing Tb of the SPAD pixel 46 in response to the reference light Lb is as shown in FIG. 15, the divided period τp (i.e., τpb which will be described later) which includes the response start timing Tb depends on the distance Lt to the target Xt. The divided period τp that includes the response start timing Tb of the SPAD pixel 46 for each delayed light Ld1, Ld2, Ld3 delays from the response start timing Tb of the SPAD pixel for the reference light Lb by the delay interval τd from one another as shown in FIGS. 16 to 18.

Thus, whether the divided periods τp including the response start timings τd for the multiple types of delayed light Ld1, Ld2, and Ld3 fall within the same sampling interval τs as the divided period τp including the response start timing Tb for the reference light Lb depends on the distance Lt to the target Xt. That is, the sampling interval τs which includes the response start timing τd for each delayed light Ld1, Ld2, Ld3 is the same with the sampling interval τs which includes the response start timing Tb of the SPAD pixel 46 for the reference light Lb, or after the sampling interval τs for the reference light Lb, depending on the distance Lt.

As shown in FIG. 15, a response timing difference ΔT is defined as a time difference between the initial timing τs of the sampling interval τs which includes the response start timing Tb of the SPAD pixel 46 for the reference light Lb and the response start timing Tb. Additionally, a divided delay time δ(κ) is defined according to the following Equation 5, using the delay interval τd of the Equation 1. The delay interval τd is the duration of the divided period τp. The divided delay time δ(κ) is a duration from the initial timing τs of the sampling interval τs which includes the response start timing Tb until the start timing of each divided period τp. In the equation 5, K is a Greek letter index, and set to an integer from 0 to K−1. The Greek letter index K identifies the divided period τp that includes the response start timing Tb. FIG. 15 representatively illustrates the divided delay time δ(κ) and the divided delay time δ(κ+1). The divided delay time δ(κ) is a duration to the divided period τp (more specifically, τpb which will be described later) that includes the response start timing Tb, and the divided delay time δ(κ+1) is a duration to the subsequent divided period τp.

$$δ ( κ ) = κ \cdot τ d \qquad ( Equation 5 )$$

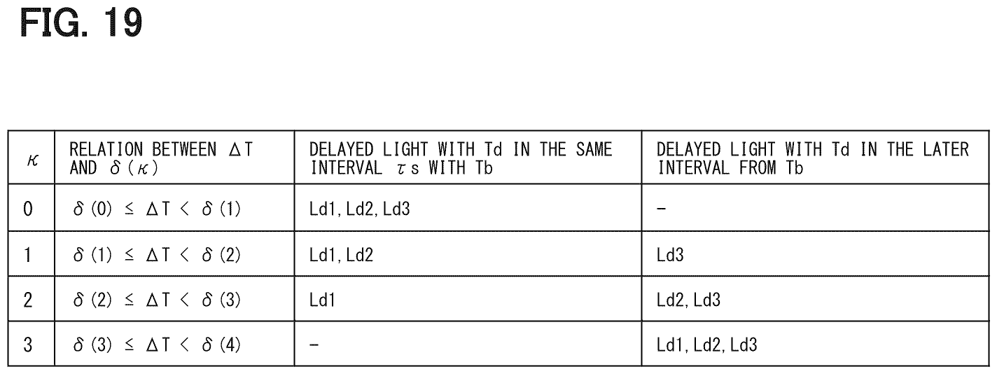

The following Equation 6 defines a relation between the response timing difference ΔT and the divided delay times δ(κ) and δ(κ+1). Under these definitions, in a sampling interval τs including the response start timing Tb for the reference light, the divided period τp which satisfies the following Equation 6 represents a specific divided period τpb. As a result, as shown in FIGS. 15 to 19, the response start timing τd for each delayed light Ld1, Ld2, and Ld3 occur in the same interval τs with the response start timing Tb or the subsequent interval τs, depending on the response timing difference ΔT. The response timing difference ΔT determines the divided delay time (κ) of the specific divided period τpb. FIGS. 15 to 18 show an example of K=2 in the Equation 6 in FIG. 19.

$$δ ( κ ) \leq Δ T < δ ( κ + 1 ) \qquad ( Equation 6 )$$

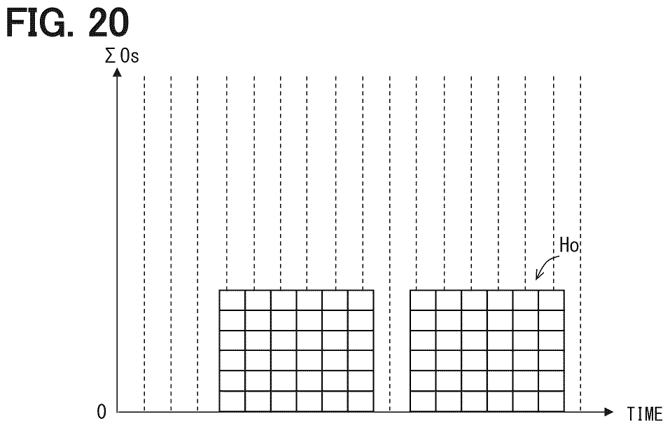

The time relationship of the sampling interval τs described above is established by the facts that the delayed control time t(k) of each delayed light Ld1, Ld2, Ld3 having a duration corresponding to the delay interval τd, which has the same duration with the divided period τp, satisfies the above Equation 3. In other words, when the delayed control time t(k) of at least one type of the delayed light Ld1, Ld2, and Ld3 is longer than the dead time ω, the time distribution of the output accumulated value ΣOs in the histogram Ho has multiple peaks as shown in FIG. 20. In this case, the time relationship of the sampling interval Is described above is not satisfied.

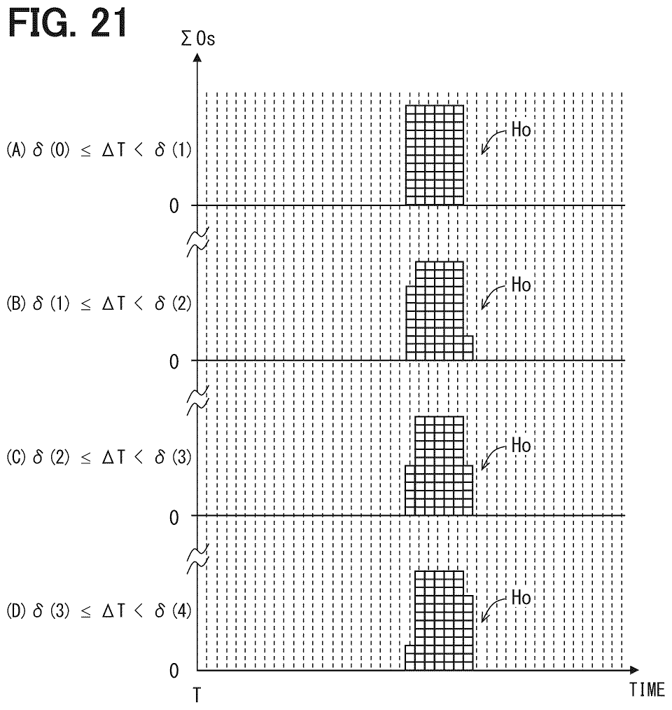

From the above findings, in the histogram Ho spanning all detection intervals τ for the total accumulation count Ns, the time distribution of the output accumulated value ΣOs changes as shown in FIG. 21, according to the response timing difference ΔT that determines the divided delay time δ(κ) of the specific divided period τpb. The output control block 110 in S60 specifies the specific divided period τpb from the time distribution of the output accumulated value ΣOs represented by the histogram Ho.

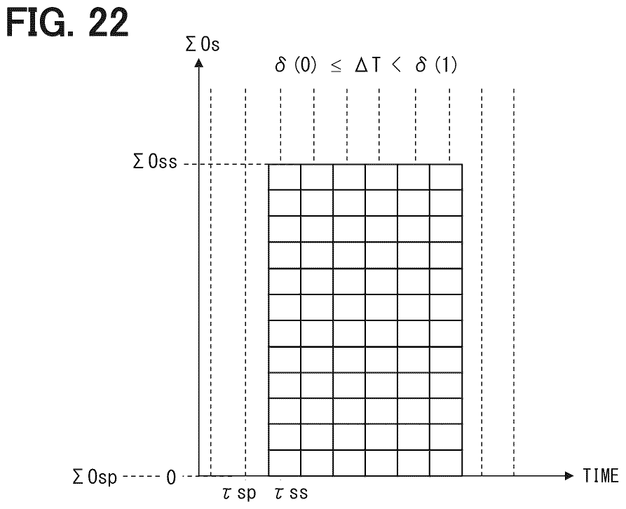

In detail, the specific divided period τpb is specified in S60 based on a focus value ΣOsp, as shown in FIGS. 22 to 25. The focus value ΣOsp is an output accumulation value ΣOs in a previous sampling interval τs that precedes a saturated sampling interval τss. The saturated sampling interval τss is a sampling interval τs in which the output accumulated value ΣOs first reaches a saturation value ΣOss for the detection frame Fτ. Here, the saturation value ΣOss is an upper response limit according to the following Equation 7, where Ne (see FIGS. 7 and 8) is the number of pairs of the elements 460 and 461 in each SPAD pixel 46.

$$\sum Oss = Ne \cdot Ns \qquad ( Equation 7 )$$

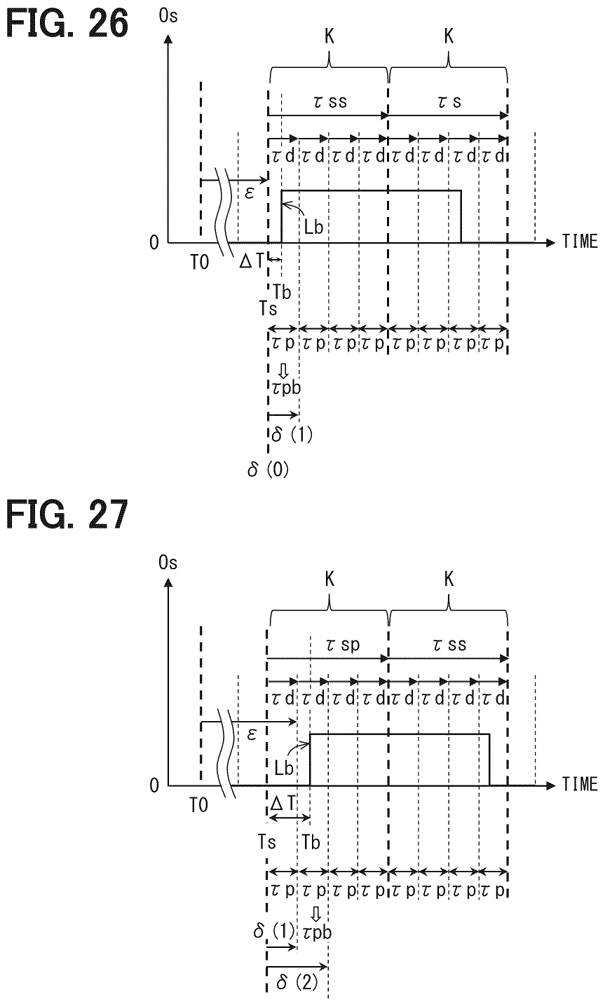

The output control block 110 in S60 outputs data on the distance Lt to the target Xt as the detection result according to the specific divided period τpb. The output control block 110 detects the distance Lt that correlates with a ranging time & from a reference timing TO (see FIG. 5) to the specific divided period τpb. The reference timing TO is defined as the start timing T of the initial detection interval τ in the detection frame Fτ. The specific divided period τpb which is shown in FIGS. 26 to 29.

Here, the ranging time & is expressed by the Equation 8 using a preceding sampling interval count Np (see FIG. 12). The preceding sampling interval count Np represents the number of preceding sampling intervals τs that follow the reference timing TO in the current detection frame Fτ and precede the initial timing τs of the sampling interval τs which includes the specific divided period τpb. FIGS. 22 and 26 show an example in which the focus value ΣOsp satisfies the following Equation 9 in the case of K=4. In this case (i.e., ΣOsp=0), the divided period τp of κ=0 is identified as the specific divided period τpb, and the specific divided period τpb belongs to the saturation period τss. The distance Lt is detected in accordance with the following Equation 10. C in Equation 10 is the speed of light.

$$ε = Np \cdot τ s + δ ( κ ) \qquad ( Equation 8 )$$

$$\sum Osp = 0 \qquad ( Equation 9 )$$

$$Lt = C \cdot ε = C \cdot \{ Np \cdot τ s + δ ( κ ) \} / 2 \qquad ( Equation 10 )$$

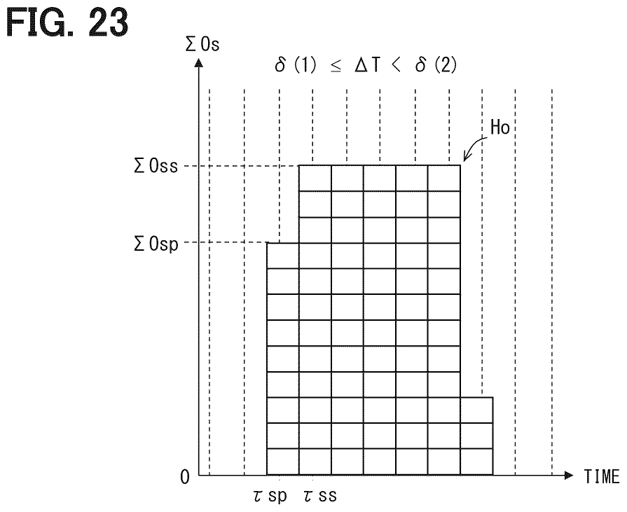

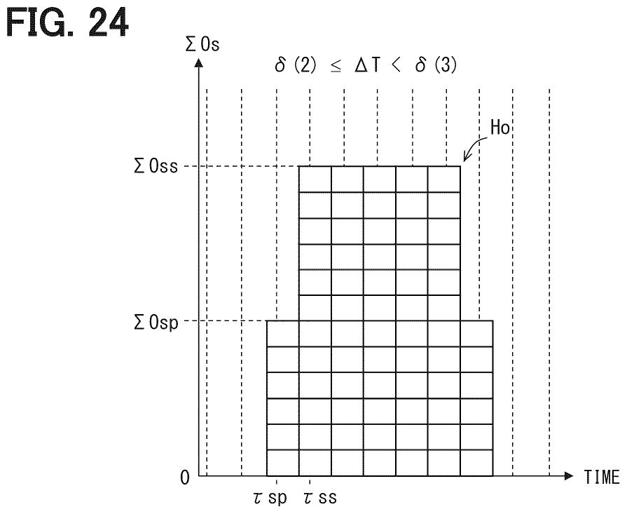

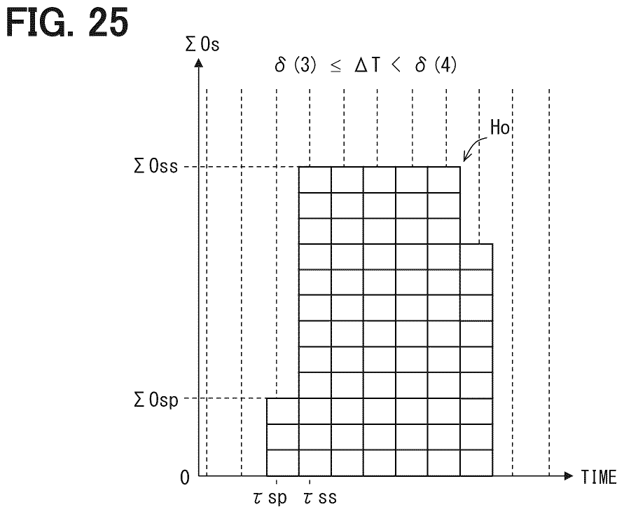

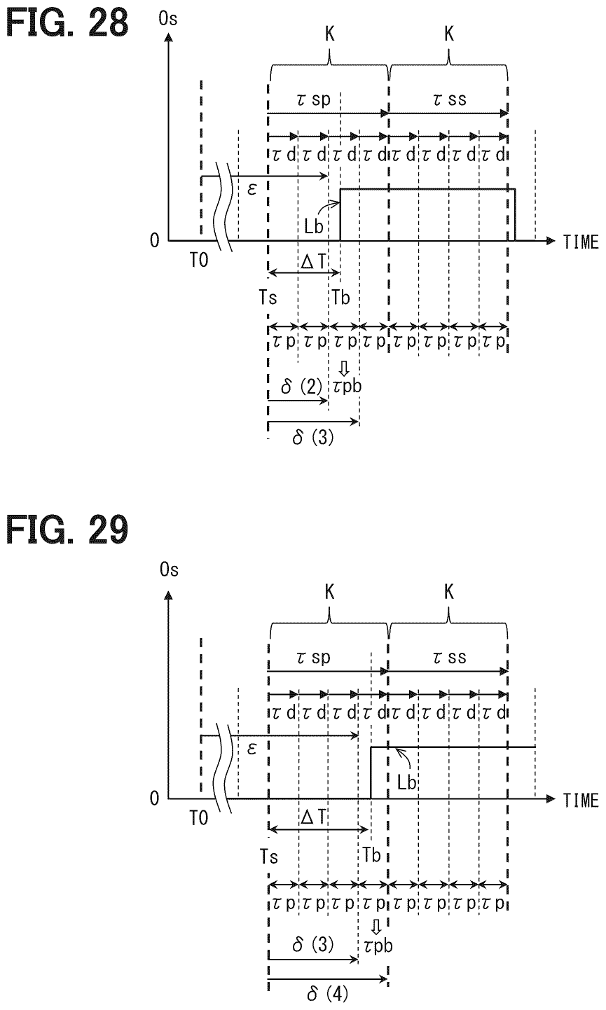

FIGS. 23 and 27 show another example where the focus value ΣOsp satisfies the following Equation 11 in the case of K=4. In this case, the divided period τp of K=1 is specified as the specific divided period τpb as shown in FIG. 27. The specific divided period τpb belongs to a previous interval τsp which precedes the saturated sampling interval τss. The distance Lt is detected in accordance with the above Equation 10. FIGS. 24 and 28 show another example where the focus value ΣOsp satisfies the Equation 11 in the case of K=4. In this case, the divided period τp of K=2 is specified as the specific divided period τpb, which belongs to the previous interval τsp. The distance Lt is detected according to the Equation 10. FIGS. 25 and 29 show another example where the focus value ΣOsp satisfies the Equation 11 in the case of K=4. In this case, the divided period τp of K=3 is specified as the specific divided period τpb, which belongs to the previous interval τsp. The distance Lt is detected according to the Equation 10.

$$Na \cdot Ne \cdot \{ K - ( κ + 1 ) \} < \sum Osp \leq Na \cdot Ne \cdot ( K - κ ) \qquad ( Equation 11 )$$

The output control block 110 in S60 stores the distance Lt detected according to the specific divided period τpb in at least one of the memory 1a in the controller 1 or the storage medium 5a in the vehicle 5 (see FIG. 1) by data output. The output control block 110 in S60 may transmit the distance Lt detected according to the specific divided period τpb to the outside of the vehicle 5 through the communication unit 5b (see FIG. 1) in the vehicle 5 by data output.

(Effects) The operation and effects of the present embodiment described so far will be described below.

In this embodiment, the irradiation light is controlled for each detection frame Fτ. The detection frame Fτ is a frame for obtaining the time distribution (specifically, the histogram Ho) of the output accumulation value of the response output Os of the SPAD pixel 46. The output accumulation value is obtained by accumulating the response output Os for multiple detection intervals τ. The response output Os is sampled at sampling intervals τs during each detection interval τ. The irradiation light includes the reference light Lb and the multiple types of delayed light Ld (specifically, Ld1, Ld2 and Ld3). The reference light Lb is emitted at a start timing T of a detection interval τ. The multiple types of delayed light are emitted in delays from the start timing T of the detection interval τ, and are different in delay by a delay interval τd from each other. The delay interval τd is less than the sampling interval τs. Thus, the output accumulated value ΣOs of the SPAD pixel 46 in response to the reference light Lb and the multiple types of delayed light Ld is acquired for each detection frame Fτ.

The sampling interval τs is subdivided with the delay interval τd into the divided periods τp. That is, the divided periods τp are portions of a sampling interval τs each having a length of the delay interval τd. According to the present embodiment described so far, the divided period τp including the response start timing of the SPAD pixel 46 for the reference light Lb depends on the distance Lt to the target Xt. The divided periods τp including the response start timings τd of the SPAD pixel 46 for multiple types of delayed light Ld shift from the divided period τp including the response start timing Tb of the SPAD pixel 46 for the reference light Lb, by the delay interval τd from each other. Whether the divided periods τp for the multiple types of delayed light which include the response start timing τd fall within the same sampling interval τs as the divided period τp for the reference light Lb which includes the response start timing Tb depends on the distance Lt to the target Xt. Thus, the time distribution of the output accumulated value ΣOs changes depending on the distance Lt to the target Xt.

In this embodiment, the specific divided period τpb is specified from the time distribution of the output accumulated value ΣOs as the divided period τp that includes the response start timing for the reference light Lb. The distance Lt according to the specific divided period τpb is output as data for each detection frame Fτ. Thus, the distance resolution can be improved according to the divided period τp that is less than the sampling interval τs. Moreover, the frame rate can be increased since the above-mentioned one-stage sampling process is repeated for each detection frame Fτ to output the distance Lt as data. As described above, it is possible to achieve both high distance resolution and a high frame rate, thereby realizing high distance detection accuracy.

In this embodiment, the specific divided period τpb is specified based on the output accumulated value ΣOs in the previous sampling interval τs (specifically, τsp) that precedes the sampling interval τs (specifically, τss) in which the output accumulated value ΣOs reaches the saturated value ΣOss. The distance Lt according to the specific divided period τpb described above is output as data for each detection frame Fτ. The output accumulation value ΣOs in the previous sampling interval τs changes within a range less than the saturation value ΣOss, depending on the distance Lt to the target Xt. Thus, the specific divided period τpb including the response start timing for the reference light Lb is accurately specified. Thus, it is possible to improve not only the distance resolution but also the resolution accuracy, thereby contributing to the realization of high distance detection accuracy.

In this embodiment, the distance Lt that correlates with the ranging time &, which is from the start timing T (specifically, TO) of the initial detection interval τ to the specific divided period τpb, is output as data for each detection frame Fτ. According to this, the ranging time & from the start of detection to the start timing Tb of the response to the reference light Lb, which is a time dependent on the distance Lt to the target Xt, can be accurately determined with an error within the range of the divided period τp, which is less than the sampling interval τs. Thus, it is possible to improve the reliability of high distance resolution accuracy, and thus the distance detection accuracy.

In this embodiment, the delayed control time t(k), which is from the start timing T of the detection interval τ to the irradiation of each delayed light Ld, is set to be less than the dead time w of the SPAD pixel 46 for each detection frame Fτ. Accordingly, it is possible to prevent a situation where it becomes difficult to accurately identify the specific divided period τpb due to the emergence of multimodality in the time distribution of the output accumulation values ΣOs. Thus, it is possible to improve not only the distance resolution but also the resolution accuracy, thereby contributing to the realization of high distance detection accuracy.

In this embodiment, the distance Lt according to the specific divided period τpb is stored at least one of the memory 1a or the storage medium 5a through data output for each detection frame Fτ. This makes it possible to read out data on the distance Lt with improved accuracy from the storage location and use it, for example, for automatic driving of the vehicle 5.

In this embodiment, the accumulation count Na of the response output Os is multiple, and the same among the reference light Lb and multiple types of delayed light Ld. The specific divided period τpb is specified based on the time distribution of the output accumulated value ΣOs obtained with such accumulation count Na. Thus, a fluctuation error in the output accumulated value ΣOs by disturbances is prevented from affecting the determination of the specific divided period τpb. Thus, the present disclosure improves both the distance resolution and the resolution accuracy, thereby contributing to the realization of high distance detection accuracy. Additionally, the high processing load in determining the specific divided period τpb, caused by the complexity of the change pattern in the time distribution of the output accumulated value ΣOs due to differences in the accumulation count Na between types of irradiation light, can be avoided. Thus, it is possible to shorten the processing time until data output and increase the frame rate.

In this embodiment, the response count Nr of the SPAD pixels 46 that have responded to the reference light Lb and multiple types of delayed light Ld is accumulated as the response output Os for each detection frame Fτ. According to this, whether the divided periods τp, including the response start timings τd for multiple types of delayed light Ld, fall within the same sampling interval Is as the divided period τp including the response start timing Tb for the reference light Lb affects the response count Nr of the SPAD pixels 46 that have responded to the irradiation light on the time axis. Thus, according to this embodiment, resolution of the distance Lt is improved based on the specific divided period τpb, which is specified from the time distribution of the output accumulated value ΣOs obtained by accumulating the response count Nr of the SPAD pixels 46. The data of the distance Lt with improved resolution is then output, enabling high distance detection accuracy.

(Other embodiments) Although one embodiment has been described, the present disclosure should not be limited to the above embodiment and may be applied to various other embodiments within the scope of the present disclosure.

The dedicated computer constituting the controller 1 may include at least one of a digital circuit or an analog circuit as a processor. The digital circuit is at least one type of, for example, an application specific integrated circuit (ASIC), a field programmable gate array (FP GA), a system on a chip (SOC), a programmable gate array (PGA), a complex programmable logic device (CPLD), and the like. Such a digital circuit may include a memory in which a program is stored.

In a modified example, the individual accumulation count Na (i.e., the individual irradiation count Ni) may be different between at least two types of irradiation light. In this modified example, it is preferable to set the difference between the individual accumulation counts Na (i.e., the difference between the individual irradiation counts Ni) to be minimized, when the total accumulation count Ns is not divisible by the distance resolution magnification value K (i.e., the number of the divided periods τp and the total number of types of irradiation light).

In modified examples, the scanning unit 31 may adopt various scanning methods such as a mechanical oscillation type limited to the horizontal direction as in the above-described embodiment, a mechanical oscillation type limited to the vertical direction, or a mechanical oscillation type in both the horizontal and vertical directions. In a modified example, a solid-state unit such as a Micro Electro Mechanical System (MEMS) may be used instead of the units 21 and 31, as long as the controller 1 can control the irradiation of the irradiation light.

In the modified examples, the vehicle 5 to which the controller 1, the optical detection system 2, the control method, and the control program are applied may be an autonomous traveling robot capable of carrying a load or collecting information by autonomous or remote driving. In addition to the above description, the embodiment and modified examples of this disclosure may be implemented in the form of a semiconductor device (e.g., a semiconductor chip) as a controller that is configured to be mounted in the vehicle 5 and includes at least one memory 1a and at least one processor 1b.

The present disclosure may be implemented in a form of a method or a program.

1. A controller configured to control an optical sensor configured to detect a distance to a target by receiving reflected lights from the target with a SPAD pixel, the reflected lights being irradiation lights by light emission, the controller comprising
a processor configured to:
control the irradiation lights to be emitted respectively in each of detection intervals, the irradiation lights including reference light and multiple types of delayed lights for each detection frame, the reference light being emitted at a start timing of a detection interval, the multiple types of delayed lights being emitted with delays from start timings of detection intervals and being different in delay by a delay interval from each other, wherein
each of the detection intervals is a duration during which response output of the SPAD pixel is repeatedly sampled at sampling intervals, each of the sampling interval is greater than the delay interval, and
each detection frame is a duration for obtaining time distribution of an output accumulated value, the time distribution of the output accumulated value being created by accumulating the response output for detection intervals; and
output data of the distance according to a specific divided period, the specific divided period being specified based on the time distribution of the output accumulated value, the specific divided period being one of divided periods which are portions of a sampling interval each having a length of the delay interval, the specific divided period including a response start timing of the SPAD pixel corresponding to the reference light.

2. The controller according to claim 1, wherein
the output accumulated value reaches a saturation value at a saturated sampling interval among the sampling intervals,
the specific divided period is specified based on the output accumulated value at a preceding sampling interval preceding the saturated sampling interval, and
the processor is configured to output the data of the distance according to the specific divided period for each detection frame.

3. The controller according to claim 2, wherein
the processor is configured to output the data of the distance that correlates with a ranging time that is from a start timing of an initial detection interval among the detection intervals to the specific divided period.

4. The controller according to claim 1, wherein
a delayed control time is defined as a time from the start timing of each of the detection intervals to an emitting timing at which each of the irradiation lights is emitted, and
the processor is configured to control the delayed control time to be less than a dead time of the SPAD pixel.

5. The controller according to claim 1, wherein
the processor is configured to store the distance according to the specific divided period on a storage medium through data output.

6. The controller according to claim 1, wherein
a number of accumulations of the response output in the time distribution of the output accumulated value is the same for each of the reference light and the multiple types of delayed lights.

7. The controller according to claim 1, wherein
a SPAD pixel is one of SPAD pixels, and
a number of the SPAD pixels that have responded to each of the reference light and the multiple types of delayed lights is accumulated as the response output to obtain the time distribution of the output accumulated value.

8. An optical detection system comprising:
an optical sensor configured to detect a distance to a target by receiving reflected lights from the target with a SPAD pixel, the reflected lights being irradiation lights by light emission; and
the controller according to claim 1.

9. A control method to control an optical sensor configured to detect a distance to a target by receiving reflected lights from the target with a SPAD pixel, the reflected lights being irradiation lights by light emission, the control method comprising:
controlling the irradiation lights to be emitted respectively in each of detection intervals, the irradiation lights including reference light and multiple types of delayed lights for each detection frame, the reference light being emitted at a start timing of a detection interval, the multiple types of delayed lights being emitted with delays from start timings of detection intervals and being different in delay by a delay interval from each other, wherein
each of the detection intervals is a duration during which response output of the SPAD pixel is repeatedly sampled at sampling intervals, each of the sampling intervals is greater than the delay interval;
obtaining time distribution of an output accumulated value for each detection frame, the time distribution of the output accumulated value being created by accumulating the response output for detection intervals;
specifying a specific divided period based on the time distribution of the output accumulated value, the specific divided period being one of divided periods which are portions of a sampling interval each having a length of the delay interval, the specific divided period including a response start timing of the SPAD pixel corresponding to the reference light; and
outputting data of the distance according to the specific divided period.

10. A computer-readable storage medium storing a control program executed by a processor to control an optical sensor configured to detect a distance to a target by receiving reflected lights from the target with a SPAD pixel, the reflected lights being irradiation lights by light emission, the control program being configured to cause the processor to:
control the irradiation lights to be emitted respectively in each of detection intervals, the irradiation lights including reference light and multiple types of delayed lights for each detection frame, the reference light being emitted at a start timing of a detection interval, the multiple types of delayed lights being emitted with delays from start timings of detection intervals and being different in delay by a delay interval from each other, wherein
each of the detection intervals is a duration during which response output of the SPAD pixel is repeatedly sampled at sampling intervals, each of the sampling intervals is greater than the delay interval, and
each detection frame is a duration for obtaining time distribution of an output accumulated value, the time distribution of the output accumulated value being created by accumulating the response output for detection intervals; and
output data of the distance according to a specific divided period, the specific divided period being specified based on the time distribution of the output accumulated value, the specific divided period being one of divided periods which are portions of a sampling interval each having a length of the delay interval, the specific divided period including a response start timing of the SPAD pixel corresponding to the reference light.
